(19) United States
(12) Patent Application Publication
(10) Pub. No.: US 2013/0198069 A1
(43) Pub. Date: Aug. 1, 2013

(54) METHODS OF PROCESSING CHECK IMAGE DATA FROM A REMOTE DEPOSIT CAPTURE DEVICE TO DETECT A DUPLICATE CHECK DEPOSIT

(71) Applicant: Paul J. Latimer, Waterloo (CA)

(72) Inventor: Paul J. Latimer, Waterloo (CA)

(73) Assignee: NCR Corporation, Duluth, GA (US)

(21) Appl. No.: 13/362,207

(22) Filed: Jan. 31, 2012

(51) Int. Cl. G06Q 40/02

(52) U.S. Cl. 705/42

(57) ABSTRACT

A method is provided of operating a check image data processing facility to detect a duplicate check deposit. The method comprises receiving from a remote deposit capture device check image data which is representative of an image of a check being deposited by the customer, determining whether a MICR code line of the check image matches a MICR code line stored in a check item database, extracting check data from at least one focus area of the check image, transmitting a message to the remote deposit capture device to indicate to the customer that the check is a duplicate check based upon the check data extracted from the at least one focus area of the check image.

### TECHNICAL FIELD

The present invention relates to remote check deposits, and is particularly directed to methods of processing check image data from a remote deposit capture device to detect a duplicate check deposit.

### BACKGROUND

A remote deposit capture device captures check image data which is representative of checks to be deposited with a financial institution, such as a bank. When a depositor deposits checks at a remote location in a check deposit transaction, the depositor scans the checks to capture image data which is representative of images of the checks. The captured check image data is electronically sent to a back office facility of the financial institution for further processing to complete the remote check deposit transaction.

Since checks can be scanned at a remote location in a remote check deposit transaction, there is potential for check fraud when a depositor intentionally deposits a check more than once. There is also potential for a depositor to make a mistake and deposit a check more than once. It would be desirable to provide a method of detecting duplicate check deposits, especially when checks are deposited at a remote location.

### SUMMARY

In accordance with one embodiment, a method is provided of operating a check image data processing facility to detect a duplicate check deposit when a customer deposits a check in a check deposit transaction at a remote deposit capture device which is remote from the check image data processing facility. The method comprises electronically by a processor, receiving from the remote deposit capture device check image data which is representative of an image of a check being deposited by the customer conducting the check deposit transaction at the remote deposit capture device. An attempt is made to read a magnetic ink character recognition (MICR) code line from the check image. A determination is made as to whether a MICR code line is readable from the check image. A determination is made as to whether the MICR code line matches a MICR code line stored in a check item database when a MICR code line is readable from the check image. Check data is extracted from at least one focus area of the check image when the MICR code line from the check image matches the MICR code line stored in the check item database. The method further comprises electronically by a processor, transmitting a message to the remote deposit capture device to indicate to the customer that the check is a duplicate check based upon the check data extracted from the at least one focus area of the check image.

### BRIEF DESCRIPTION OF THE DRAWINGS

The present invention may take form in various components and arrangement of components and in various methods. The drawings are only for purposes of illustrating example embodiments and alternatives and are not to be construed as limiting the invention.

FIG. 1 is a block diagram of a networked system of a check image data processing center in communication with a number of different types of remote deposit capture devices in accordance with one embodiment.

FIG. 2 is an example of a first check which can be deposited at a remote deposit capture device shown in FIG. 1.

FIG. 3 is an example of a second check which has already been deposited.

FIG. 4 is a table showing weighting factors associated with different focus areas of a check image.

FIG. 5 is a flowchart illustrating steps involved in a duplicate check detection operation in accordance with one embodiment.

FIGS. 6-19 are diagrams showing example horizontal histograms and example vertical histograms associated with the focus areas of FIG. 4.

### DETAILED DESCRIPTION

The present invention is directed to methods of processing check image data from a remote deposit capture device to detect a duplicate check deposit. The specific type and construction of the remote deposit capture device may vary.

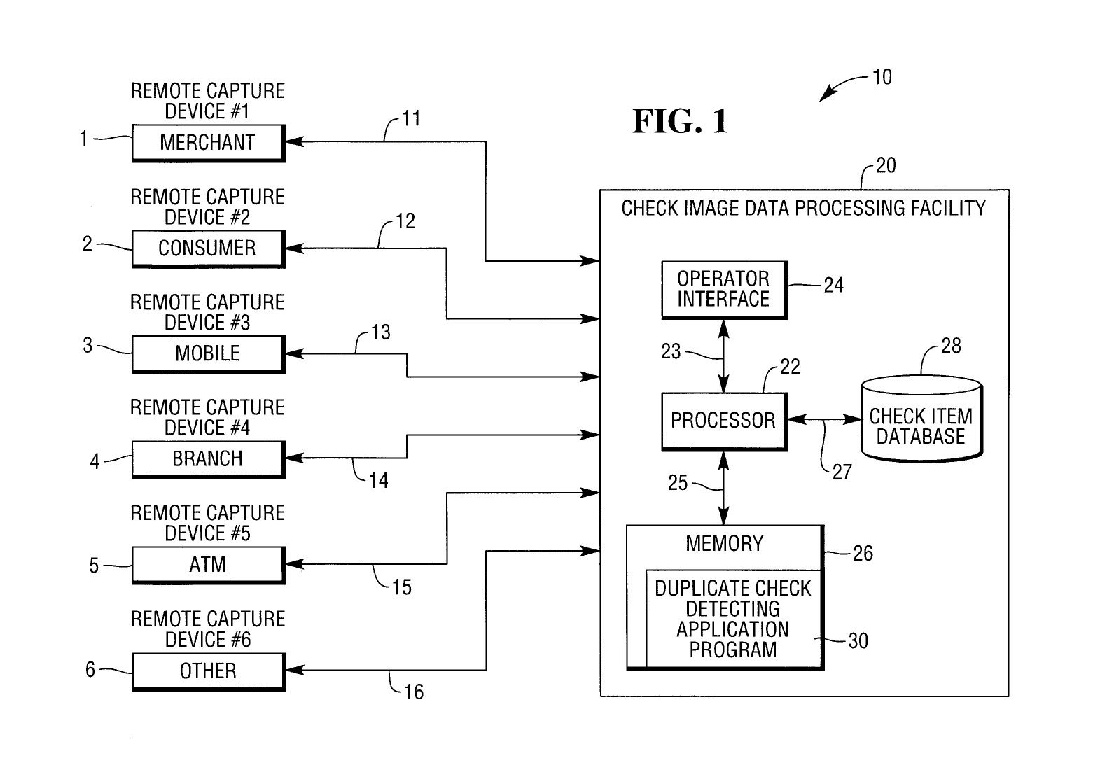

As shown in FIG. 1, a networked system 10 includes check image data processing facility 20 which communicates with a number of different types of remote deposit capture devices 1, 2, 3, 4, 5, 6 via signals on lines 11, 12, 13, 13, 15, 16, respectively. More specifically, remote deposit capture device 1 may be located at a merchant facility, such as a retail grocery store, for allowing a retail merchant to capture an image of a check received from a retail customer during a retail transaction. Remote deposit capture device 1 may comprise a scanner which is part of a point-of-sale (POS) terminal, for example. As another example, remote deposit capture device 1 may comprise a commercial-grade, digital flatbed scanner. Remote deposit capture device 2 may be located in a home of a consumer, such as a home office, for allowing the consumer to capture images of checks to be deposited. Remote deposit capture device 2 may comprise a non-commercial-grade, digital flatbed scanner, for example.

Remote deposit capture device 3 is a mobile device, such as a cell phone, which has a built-in digital camera for capturing images of checks to be deposited. The mobile device 3 with built-in digital camera is carried by a mobile device user and goes where the mobile device user goes. Remote deposit capture device 4 is located at a financial institution, such as a bank branch. Remote deposit capture device 4 may comprise a tabletop check scanner located at a teller station of a bank branch to allow a bank teller to scan and capture images of checks to be deposited by a bank customer. Remote deposit capture device 5 is an image-based self-service check depositing terminal, such as an image-based check depositing automated teller machine (ATM), at which checks can be deposited. These are only example types of remote deposit capture devices, and other types of remote deposit capture devices 6 as shown in FIG. 1 are possible.

Check image data processing facility 20 may be located in a back office facility of a financial institution. Check image data processing facility 20 includes processor 22 and operator interface 24 which communicates via signals on line 23 with processor 22. Operator interface 24 may include a keyboard, a mouse, and a display, all of which communicate via signals on line 23 with processor 22. Check image data processing facility 20 further includes memory 26 which communicates via signals on line 25 with processor 22. Memory 26 may comprise a single memory unit or a plurality of different memory units. Duplicate check detecting application program 30 is stored in memory 26, and will be described later. Check image data processing facility 20 further includes check item database 28 which communicates via signals on line 27 with processor 22. Check item database 28 will also be described later.

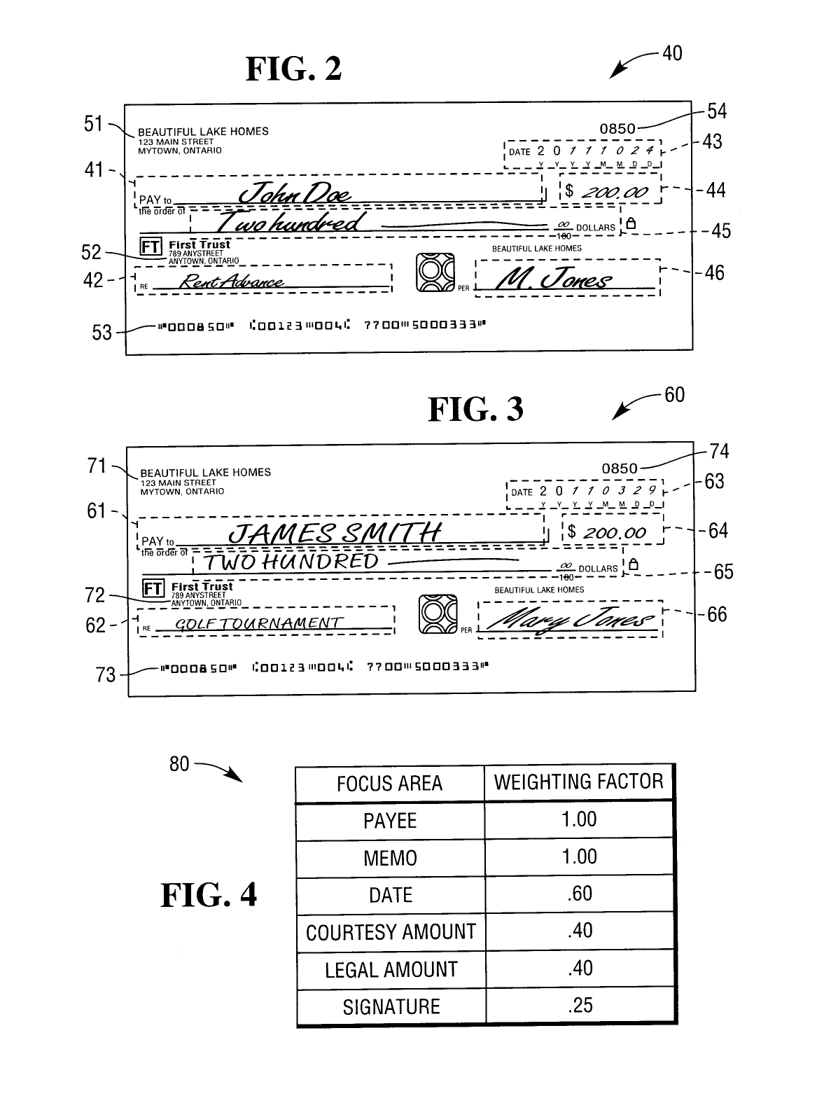

Referring to FIG. 2, an image of a first check 40 written by “Mary Jones” to “John Doe” is illustrated. For simplicity, the check image of check 40 will also be referred to herein as “check 40”. Check 40 includes a payee field 41, a memo field 42, a date field 43, a courtesy amount field 44, a legal amount field 45, and a payer signature field 46. Fields 41, 42, 43, 44, 45, 46 are focus areas of check 40 to be described later. Check 40 also includes a payer field 51, a paying bank name field 52, a MICR code line field 53, and a check number field 54.

Referring to FIG. 3, an image of a second check 60 written by “Mary Jones” to “James Smith” is illustrated. For simplicity, the check image of check 60 will also be referred to herein as “check 60”. Check 60 includes a payee field 61, a memo field 62, a date field 63, a courtesy amount field 64, a legal amount field 65, and a payer signature field 66. Fields 61, 62, 63, 64, 65, 66 are focus areas of check 60 to be described later. Check 60 also includes a payer field 71, a paying bank name field 72, a MICR code line field 73, and a check number field 74.

Referring to FIG. 4, a table 80 shows weighting factors associated with the six focus areas of check 40 and the six focus areas of check 60 described hereinabove. As shown in FIG. 4, each of payee fields 41, 61 and each of memo fields 42, 62 has a weighting factor of 1.00. Each of date fields 43, 63 has a weighting factor of 0.60, and each of courtesy amount fields 44, 64 has a weighting factor of 0.40. Each of legal amount fields 45, 65 has a weighting factor of 0.40, and each of payer signature fields 46, 66 has a weighting factor of 0.25. The weighting factors shown in table 80 are only example weighting factors. Different weighting factors are possible for each focus area, and may be changed as required for the particular application environment.

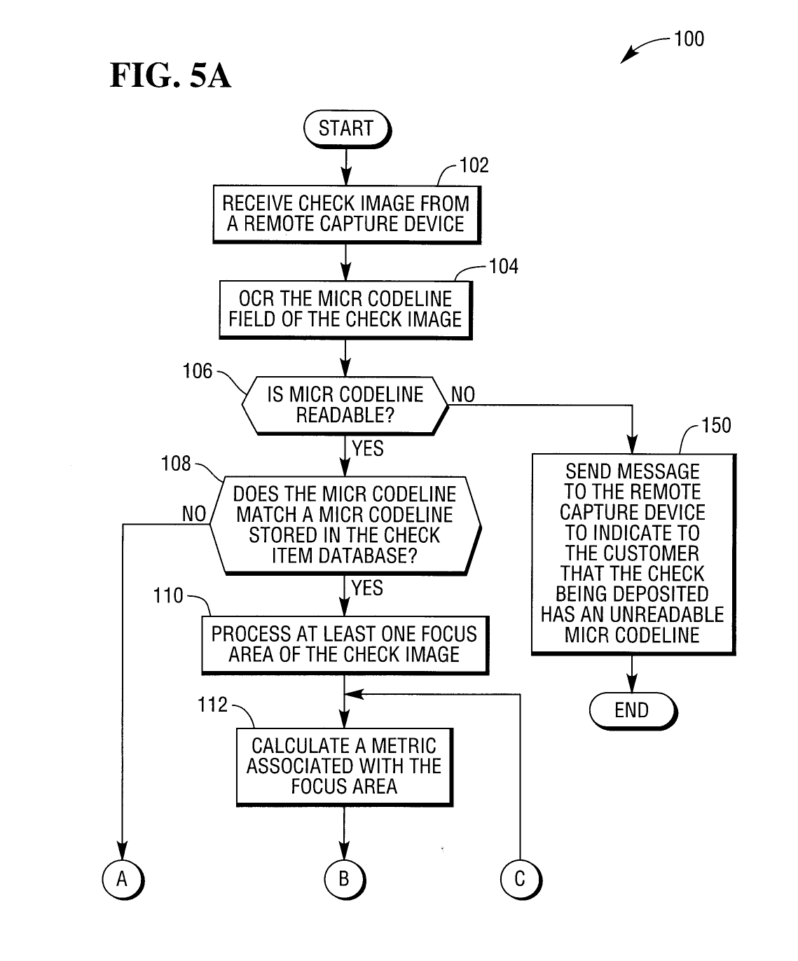

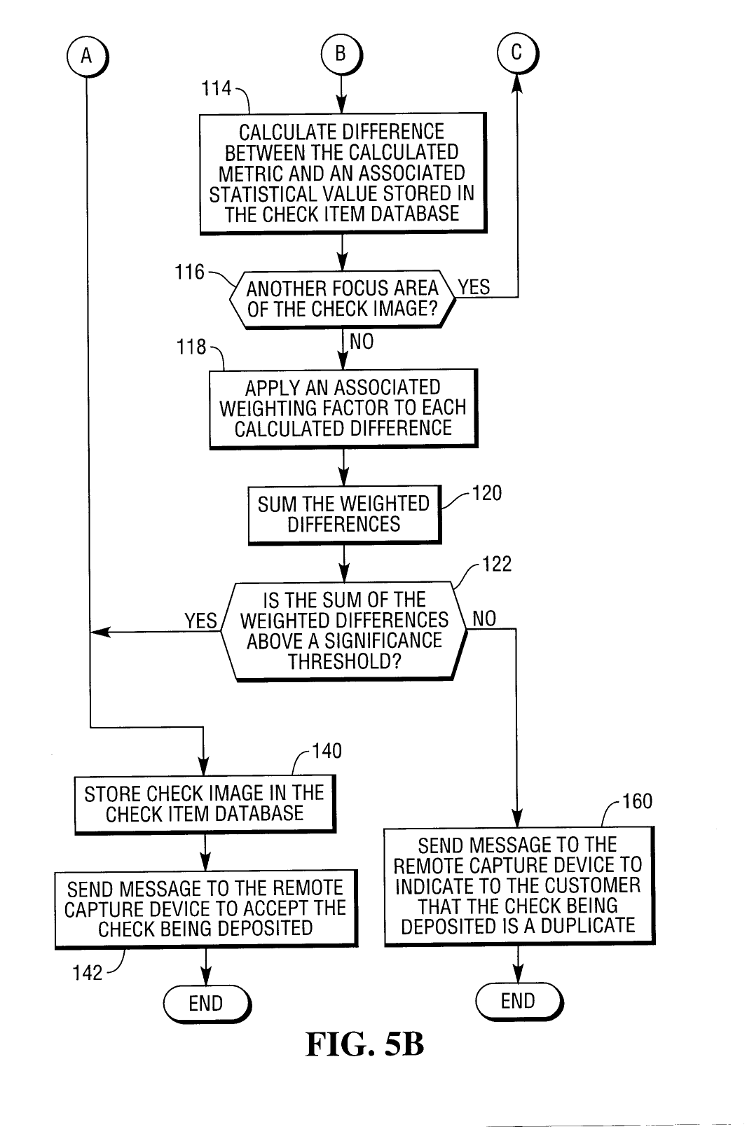

Referring to FIG. 5, flowchart 100 depicts steps involved in a duplicate check detection operation performed by duplicate check detecting application program 30 in accordance with one embodiment. Steps involved in duplicate check detection of check 40 are the same as steps involved in duplicate check detection of check 60. For purposes of explanation, it will be assumed that second check 60 has already been deposited and that the check image data associated with second check 60 is already stored in check item database 28. It will also be assumed that first check 40 is in process of being deposited at one of the remote deposit capture devices 1, 2, 3, 4, 5, 6 shown in FIG. 1.

As shown in step 102 in FIG. 5, check image data (of first check 40) which has been captured at the remote deposit capture device is received. Then, in step 104, processor 22 attempts to perform an optical character recognition (OCR) read of MICR code line field 53 of check 40. Alternatively, a MICR code line reader (not shown) may be used to perform a MICR read of MICR code line field 53 of check 40. A determination is made in step 106 as to whether a MICR code line can be read from the MICR code line field 53 of check 40. If the determination in step 106 is negative (i.e., a MICR code line is unable to be read from the MICR code line field), then the process proceeds to step 160 in which a message is sent to the remote deposit capture device to indicate to the customer at the remote deposit capture device that the check 40 being deposited is unacceptable for deposit since MICR code line field 53 is unreadable. The process then ends.

However, if the determination in step 106 is affirmative (i.e., a MICR code line is able to be read from MICR code line field 53), then the process proceeds to step 108. In step 108, a determination is made as to whether the MICR code line which has just been read from check 40 matches a MICR code line stored in the check item database 28. If the determination in step 108 is negative (i.e., the MICR code line read from check 40 does not match a MICR code line stored in check item database 28), then the process proceeds to step 140. In step 140, check 40 is stored in check item database 28. Then, in step 142, a message is sent to the remote deposit capture device to indicate to the customer that the check being deposited is accepted for deposit.

However, if the determination back in step 108 is affirmative (i.e., the MICR code line read from check 40 matches a MICR code line stored in the check item database 28), then the process proceeds to step 110 in which data is extracted from at least one focus area of check 40. For purposes of description, the payee field 41 of check 40 is considered as a focus area from which data is extracted and processed. In step 112, a metric associated with the payee field 41 is calculated. An example metric which can be calculated for payee field 41 is counting the number of black pixels in a sampled column. Then, a difference between the calculated metric and an associated statistical value stored in the check item database 28 is calculated (step 114) to provide an indication of the degree of statistical correlation.

In step 116, a determination is made as to whether another focus area of check 40 is to be considered for data extraction and processing. If the determination in step 116 is affirmative (i.e., there is another focus area of check 40 to be considered), then the process proceeds back to step 112 to calculate a metric associated with this focus area. For purposes of description, it will be assumed that the focus area of the date field 43 of check 40 will also be considered. Accordingly, a metric associated with the date field 43 is calculated, and a difference between this calculated metric and an associated statistical value stored in the check item database 28 is calculated. An example metric which can be calculated for date field 43 is counting the number of black pixels in a sampled column.

However, if the determination in step 116 is negative (i.e., another focus area of check 40 is not to be considered), then the process proceeds to step 118. Based upon the assumption that only the payee field 41 and the date field 43 of check 40 are being considered, then the process will proceed to step 118 after a difference associated with the payee field 41 and a difference associated with the date field 43 have been calculated.

In step 118, a corresponding weighting factor is applied to the calculated difference associated with the payee field 41, and a corresponding weighting factor is applied to the calculated difference associated with the date field 43. As shown in the table 80 of FIG. 4, a weighting factor of 1.00 is applied to the calculated difference associated with the payee field 41, and a weighting factor of 0.60 is applied to the calculated difference associated with the date field 43. The weighted difference associated with the payee field 41 and the weighted difference associated with the date field 43 are then summed together (step 120).

A determination is then made as to whether the sum of the weighted difference associated with the payee field 41 and the weighted difference associated with the date field 43 is greater than a predetermined significance threshold value (step 122). The predetermined significance threshold value may be stored in memory 26 (FIG. 1). If the determination in step 122 is affirmative (i.e., the sum of the two weighted differences is greater than the predetermined significance threshold value), then the process proceeds to step 140. In step 140, the check 40 is stored in the check item database 28. The calculated metric for each of the different focus areas may also be stored in check item database 28. This will eliminate re-calculation of these metrics when comparing a newly deposited check to items in the database 28. Then, in step 142, a message is sent to the remote deposit capture device to indicate to the customer that the check being deposited is accepted for deposit. The process then ends.

However, if the determination back in step 122 is negative (i.e., the sum of the weighted differences is not greater than the predetermined significance threshold value), then the process proceeds to step 160. In step 160, a message is sent to the remote deposit capture device to indicate to the customer that the check 40 being deposited is unacceptable for deposit since the check is considered to be a duplicate. The process then ends.

It should be apparent that the example method described hereinabove provides a duplicate check deposit detecting feature which is based upon selective image comparison which meets predetermined criteria. Image comparison is selective in that some combination of focus areas of a check image are analyzed to determine if a duplicate check is being deposited. By selectively comparing focus areas of a check image, a more reliable way is provided to detect true duplicate checks and to prevent such duplicate checks from being deposited. As a result of the more reliable way of detecting true duplicate checks, the number of false positives (i.e., the number of times a duplicate check is detected when in fact there is no duplicate check) is reduced.

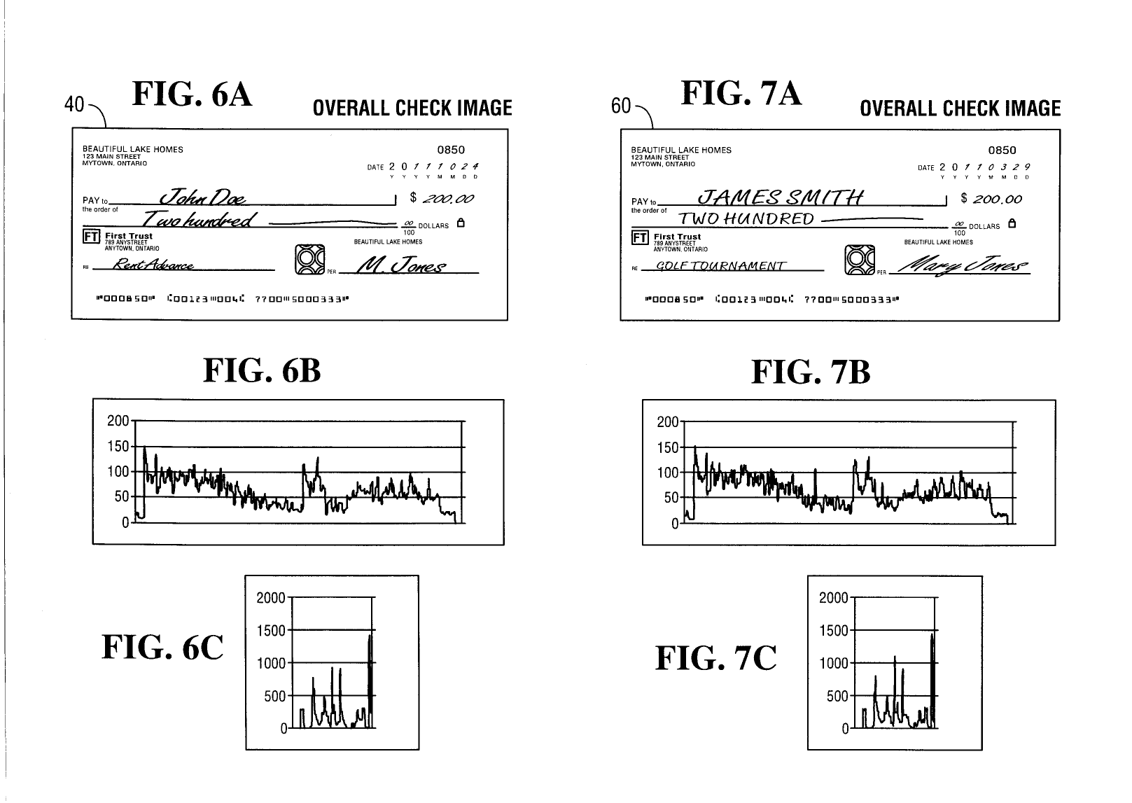

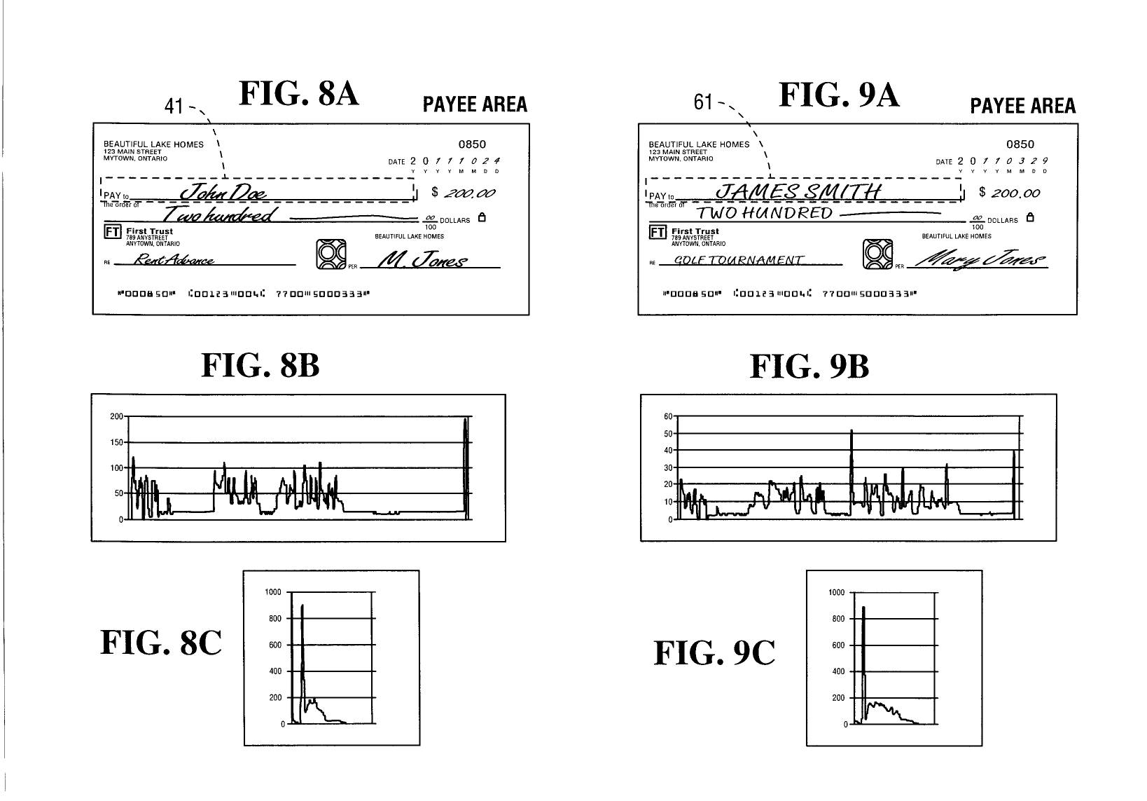

The higher reliability provided by extracting and processing data from focus areas of a check image can also be explained by comparing histograms associated with the overall check images (as shown in FIGS. 6 and 7) and histograms associated with just focus areas of the check images (as shown in FIGS. 8-19). Construction and analysis of histograms are well known and, therefore, will not be described. It should be noted that the histograms shown in FIGS. 6-19 are associated with real check images having real names and real bank account particulars. The real names and the real bank account particulars have been deleted and changed to fictitious names and fictitious bank account particulars shown in the check images of FIGS. 6-19 to protect privacy of individuals. It should also be noted that the histograms shown in FIGS. 6-19 were created by using a sampling rate to provide an image resolution of about 200 dots-per-inch. It is conceivable that a different sampling rate be used. By providing a lower resolution, a lower sampling rate could have been used to provide a lower resolution of about 40 dots-per-inch. In this example, the overall shapes of the histograms are maintained while the data size of the stored histograms as well as the processor time required for correlation testing are reduced.

Referring to FIGS. 6 and 7, the overall image of the check 40 (FIG. 6A) and the overall image of the check 60 (FIG. 7A) are illustrated. Horizontal histogram of overall image of the check 40 (FIG. 6B) and horizontal histogram of overall image of the check 60 (FIG. 7B) are also shown. Similarly, vertical histogram of overall image of the check 40 (FIG. 6C) and vertical histogram of overall image of the check 60 (FIG. 7C) are shown. It should be noted that the horizontal histogram of FIG. 6B is similar to the horizontal histogram of FIG. 7B, and that the vertical histogram of FIG. 6C is similar to the vertical histogram of FIG. 7C. There are only relatively small differences between the horizontal histograms (FIGS. 6B and 7B) and the vertical histograms (FIGS. 6C and 7C) of the two somewhat similar overall check images shown in FIGS. 6A and 7A. Accordingly, even though the two checks 40, 60 (FIGS. 6A and 7A, respectively) are clearly not duplicates, there is a relatively high chance of a false positive of a duplicate check being detected when either the horizontal histograms and/or the vertical histograms associated with the overall check images are compared.

Referring to FIGS. 8 and 9, only the focus area of payee field 41 of check 40 (FIG. 8A) and only the focus area of payee field 61 of check 60 (FIG. 9A) are illustrated. Horizontal histogram of the focus area of payee field 41 of check 40 (FIG. 8B) and horizontal histogram of the focus area of payee field 61 of check 60 (FIG. 9B) are also illustrated. Similarly, vertical histogram of the focus area of payee field 41 of check 40 (FIG. 8C) and vertical histogram of the focus area of payee field 61 of check 60 (FIG. 9C) are illustrated. It should be noted that the horizontal histogram of FIG. 8B and the horizontal histogram of FIG. 9B are quite different. It should also be noted that the vertical histogram of FIG. 8C and the vertical histogram of FIG. 9C are also different, but not as different as their related horizontal histograms shown in FIGS. 8B and 9B. Based upon the relatively greater amount of difference between the horizontal histogram associated with the focus area of the payee field 41 of check 40 shown in FIG. 8B and the horizontal histogram associated with the payee field 61 of check 60 shown in FIG. 9B (as compared to the relatively smaller amount of difference between the horizontal histogram of the overall image of check 40 shown in FIG. 6B and the horizontal histogram of the overall image of check 60 shown in FIG. 7B), a more reliable basis is provided for determining that check 40 is not a duplicate of check 60 when check 40 is being deposited at the remote deposit capture device.

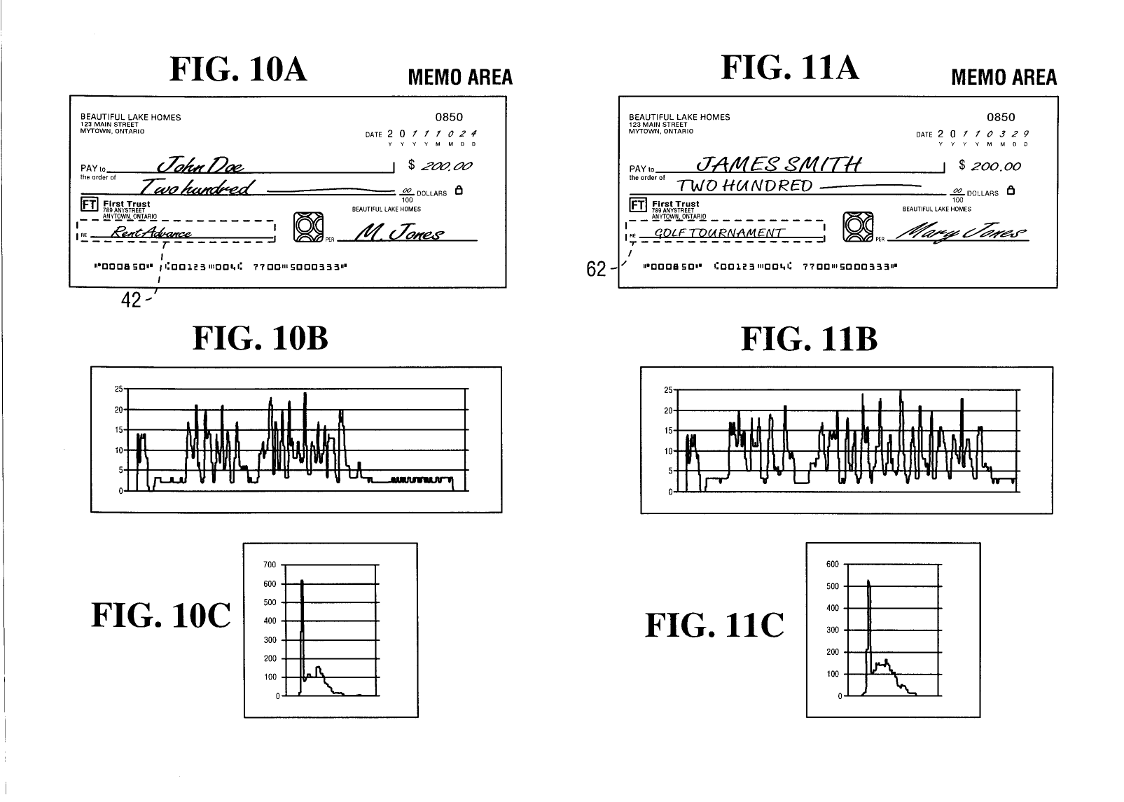

Referring to FIGS. 10 and 11, only the focus area of memo field 42 of check 40 (FIG. 10A) and only the focus area of memo field 62 of check 60 (FIG. 11A) are illustrated. Horizontal histogram of the focus area of memo field 42 of check 40 (FIG. 10B) and horizontal histogram of the focus area of memo field 62 of check 60 (FIG. 11B) are also illustrated. Similarly, vertical histogram of the focus area of memo field 42 of check 40 (FIG. 10C) and vertical histogram of the focus area of memo field 62 of check 60 (FIG. 11C) are illustrated. It should be noted that the horizontal histogram of FIG. 10B and the horizontal histogram of FIG. 11B are quite different. It should also be noted that the vertical histogram of FIG. 10C and the vertical histogram of FIG. 11C are also different, but not as different as their related horizontal histograms shown in FIGS. 10B and 11B. Based upon the relatively greater amount of difference between the horizontal histogram associated with the focus area of the memo field 42 of check 40 shown in FIG. 10B and the horizontal histogram associated with the memo field 62 of check 60 shown in FIG. 11B (as compared to the relatively smaller amount of difference between the horizontal histogram of the overall image of check 40 shown in FIG. 6B and the horizontal histogram of the overall image of check 60 shown in FIG. 7B), a more reliable basis is provided for determining that check 40 is not a duplicate of check 60 when check 40 is being deposited at the remote deposit capture device.

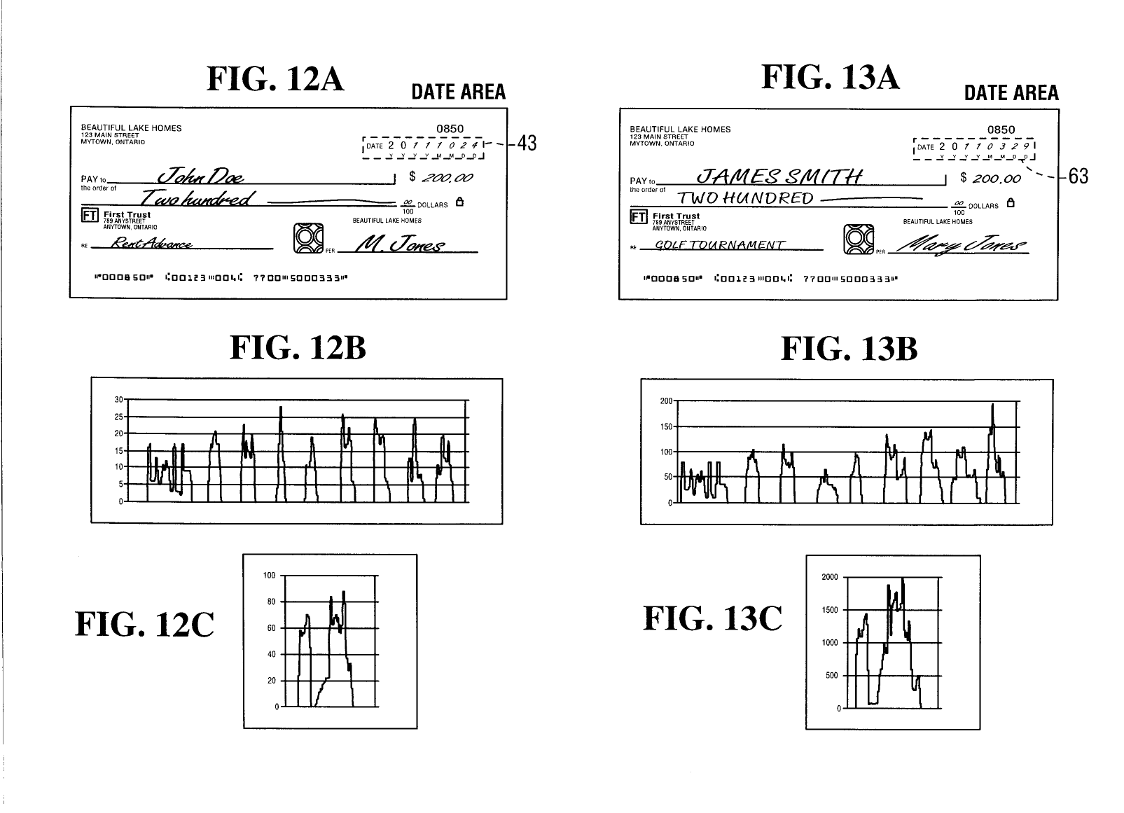

Referring to FIGS. 12 and 13, only the focus area of date field 43 of check 40 (FIG. 12A) and only the focus area of date field 63 of check 60 (FIG. 13A) are illustrated. Horizontal histogram of the focus area of date field 43 of check 40 (FIG. 12B) and horizontal histogram of the focus area of date field 63 of check 60 (FIG. 13B) are also illustrated. Similarly, vertical histogram of the focus area of date field 43 of check 40 (FIG. 12C) and vertical histogram of the focus area of date field 63 of check 60 (FIG. 13C) are illustrated. It should be noted that the horizontal histogram of FIG. 12B and the horizontal histogram of FIG. 13B are quite different. It should also be noted that the vertical histogram of FIG. 12C and the vertical histogram of FIG. 13C are also different, but not as different as their related horizontal histograms shown in FIGS. 12B and 13B. Based upon the relatively greater amount of difference between the horizontal histogram associated with the focus area of the date field 43 of check 40 shown in FIG. 12B and the horizontal histogram associated with the date field 63 of check 60 shown in FIG. 13B (as compared to the relatively smaller amount of difference between the horizontal histogram of the overall image of check 40 shown in FIG. 6B and the horizontal histogram of the overall image of check 60 shown in FIG. 7B), a more reliable basis is provided for determining that check 40 is not a duplicate of check 60 when check 40 is being deposited at the remote deposit capture device.

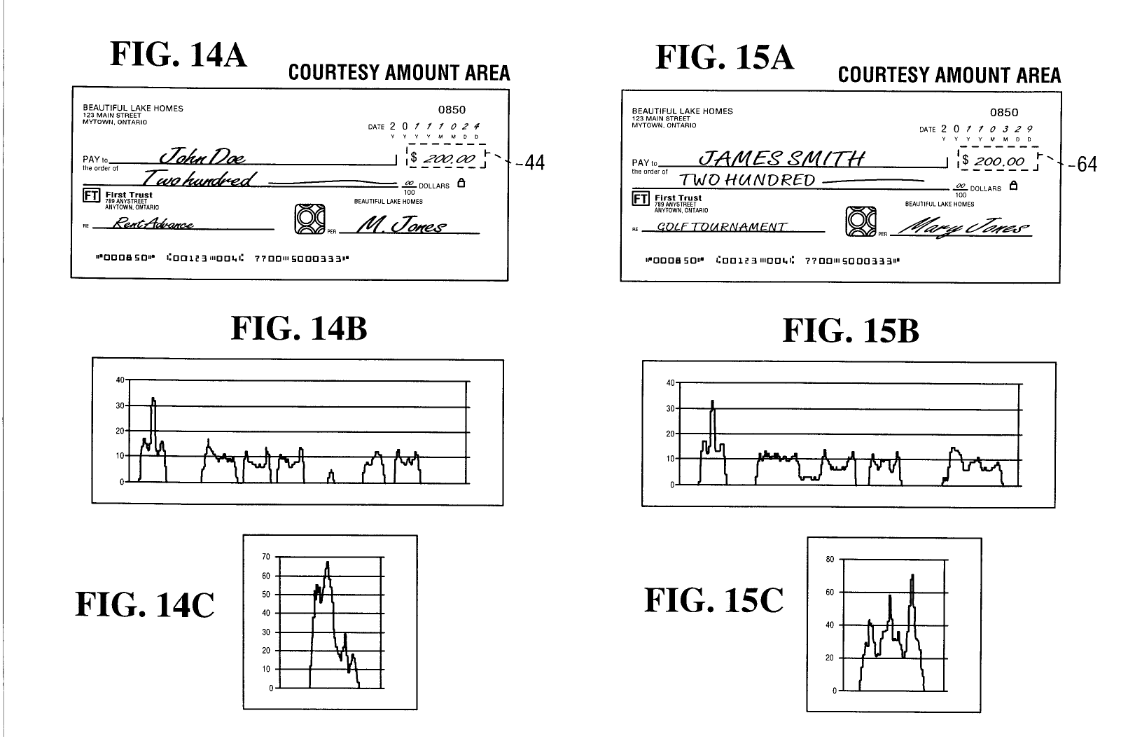

Referring to FIGS. 14 and 15, only the focus area of courtesy amount field 44 of check 40 (FIG. 14A) and only the focus area of courtesy amount field 64 of check 60 (FIG. 15A) are illustrated. Horizontal histogram of the focus area of courtesy amount field 44 of check 40 (FIG. 14B) and horizontal histogram of the focus area of courtesy amount field 64 of check 60 (FIG. 15B) are also illustrated. Similarly, vertical histogram of the focus area of courtesy amount field 44 of check 40 (FIG. 14C) and vertical histogram of the focus area of courtesy amount field 64 of check 60 (FIG. 15C) are illustrated. It should be noted that the horizontal histogram of FIG. 14B and the horizontal histogram of FIG. 15B are quite different. It should also be noted that the vertical histogram of FIG. 14C and the vertical histogram of FIG. 15C are also quite different. Based upon the relatively greater amount of difference between the horizontal histogram associated with the focus area of the courtesy amount field 44 of check 40 shown in FIG. 14B and the horizontal histogram associated with the courtesy amount field 64 of check 60 shown in FIG. 15B and also between the vertical histogram associated with the focus area of the courtesy amount field 44 of check 40 shown in FIG. 14C and the vertical histogram associated with the courtesy amount field 64 of check 60 shown in FIG. 15C (as compared to the relatively smaller amount of difference between the horizontal histogram of the overall image of check 40 shown in FIG. 6B and the horizontal histogram of the overall image of check 60 shown in FIG. 7B and also the relatively smaller amount of difference between the vertical histogram of the overall image of check 40 shown in FIG. 6C and the vertical histogram of the overall image of check 60 shown in FIG. 7C), a more reliable basis is provided for determining that check 40 is not a duplicate of check 60 when check 40 is being deposited at the remote deposit capture device.

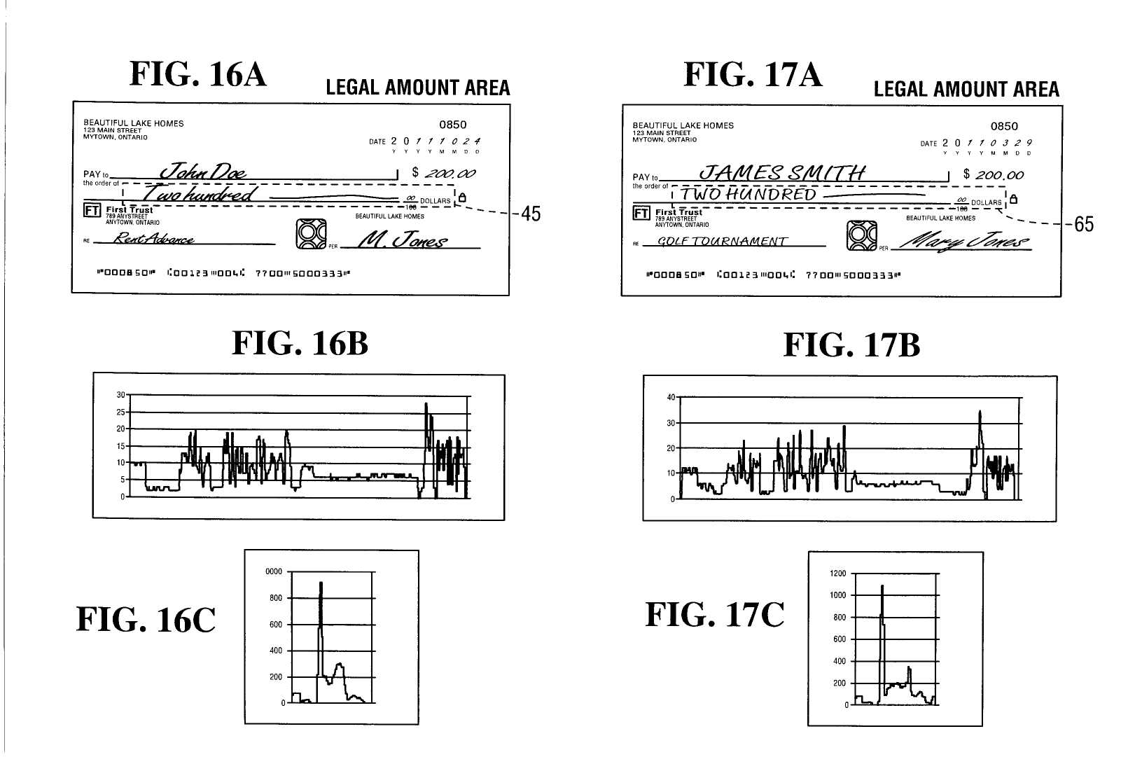

Referring to FIGS. 16 and 17, only the focus area of legal amount field 45 of check 40 (FIG. 16A) and only the focus area of legal amount field 65 of check 60 (FIG. 17A) are illustrated. Horizontal histogram of the focus area of legal amount field 45 of check 40 (FIG. 16B) and horizontal histogram of the focus area of legal amount field 65 of check 60 (FIG. 17B) are also illustrated. Similarly, vertical histogram of the focus area of legal amount field 45 of check 40 (FIG. 16C) and vertical histogram of the focus area of legal amount field 65 of check 60 (FIG. 17C) are illustrated. It should be noted that the horizontal histogram of FIG. 16B and the horizontal histogram of FIG. 17B are somewhat different. It should also be noted that the vertical histogram of FIG. 16C and the vertical histogram of FIG. 17C are also somewhat different. Based upon the somewhat greater amount of difference between the horizontal histogram associated with the focus area of the legal amount field 45 of check 40 shown in FIG. 16B and the horizontal histogram associated with the legal amount field 65 of check 60 shown in FIG. 17B and also between the vertical histogram associated with the focus area of the legal amount field 44 of check 40 shown in FIG. 16C and the vertical histogram associated with the legal amount field 65 of check 60 shown in FIG. 17C (as compared to the relatively smaller amount of difference between the horizontal histogram of the overall image of check 40 shown in FIG. 6B and the horizontal histogram of the overall image of check 60 shown in FIG. 7B and also the relatively smaller amount of difference between the vertical histogram of the overall image of check 40 shown in FIG. 6C and the vertical histogram of the overall image of check 60 shown in FIG. 7C), a somewhat more reliable basis is provided for determining that check 40 is not a duplicate of check 60 when check 40 is being deposited at the remote deposit capture device.

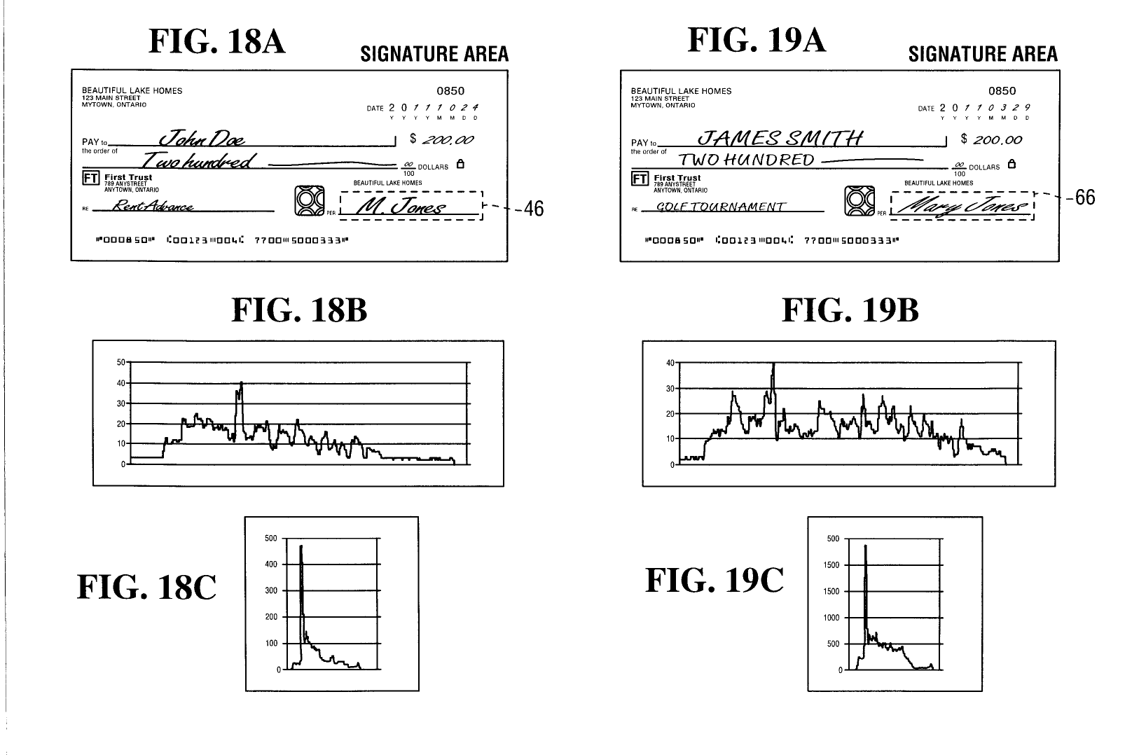

Referring to FIGS. 18 and 19, only the focus area of payer signature field 46 of check 40 (FIG. 18A) and only the focus area of payer signature field 66 of check 60 (FIG. 19A) are illustrated. Horizontal histogram of the focus area of payer signature field 46 of check 40 (FIG. 18B) and horizontal histogram of the focus area of payer signature field 66 of check 60 (FIG. 19B) are also illustrated. Similarly, vertical histogram of the focus area of payer signature field 46 of check 40 (FIG. 18C) and vertical histogram of the focus area of payer signature field 66 of check 60 (FIG. 19C) are illustrated. It should be noted that the horizontal histogram of FIG. 18B and the horizontal histogram of FIG. 19B are quite different. It should also be noted that the vertical histogram of FIG. 18C and the vertical histogram of FIG. 19C are also different, but not as different as their related horizontal histograms shown in FIGS. 18B and 19B. Based upon the relatively greater amount of difference between the horizontal histogram associated with the focus area of the payer signature field 46 of check 40 shown in FIG. 18B and the horizontal histogram associated with the payer signature field 66 of check 60 shown in FIG. 19B (as compared to the relatively smaller amount of difference between the horizontal histogram of the overall image of check 40 shown in FIG. 6B and the horizontal histogram of the overall image of check 60 shown in FIG. 7B), a more reliable basis is provided for determining that check 40 is not a duplicate of check 60 when check 40 is being deposited at the remote deposit capture device.

The above-described comparisons of the six horizontal histograms and the six vertical histograms between the two checks 40, 60 were based upon consideration of one focus area at a time. It is conceivable that any combination of different focus areas may be considered at one time by applying weighting factors (such as shown in the table 80 of FIG. 4) to the different focus areas of the two checks 40, 60. It is also conceivable that focus areas other than the six focus areas described hereinabove may be considered along with their corresponding weighting factors.

The above-described duplicate check deposit detecting feature based on selective image comparison may be implemented by an algorithm which is expressed in a computer program containing executable instructions which, when executed, carry out steps of the algorithm to provide the feature. The selective image comparison solution allows duplicate check deposits which are being made at remote locations, such as at digital flatbed scanners, mobile devices with built-in digital cameras, and ATMs, to be detected before the fact and not after the fact. The result is duplicate checks being prevented from being deposited. Accordingly, duplicate check deposits as well as subsequent processing to make adjustments and corrections to a depositor's account are avoided. The result is cost savings during operation of the networked system 10 of check image data processing facility 20 and remote deposit capture devices 1, 2, 3, 4, 5, 6 shown in FIG. 1.

The above-described example method is performed by a computer having a memory executing one or more programs of instructions which are tangibly embodied in a program storage medium readable by the computer. A single computer may perform the example method described hereinabove. However, it is conceivable that more than one computer perform the example method described hereinabove.

Although the above description describes check image data processing center 20 as being located at a back office facility of a financial institution, it is conceivable that the check image data processing center 20 be located at a different type of facility. For example, check image data processing center 20 may comprise a third-party provider who provides a service to financial institutions to detect duplicate checks being deposited at remote deposit capture devices such as shown in FIG. 1, and thereby to prevent duplicate checks from being deposited.

Also, although the above description describes the check item database 28 of the check image data processing center 20 being located at the same location as processor 22, it is conceivable that check item database 28 be located at a location which is remote from processor 22. It is also conceivable that operator interface 24 of check image data processing center 20 be located at a location which is remote from processor 22.

Further, although the above description describes a duplicate check detection operation involving only one check being deposited, it is conceivable that the duplicate check deposit detection operation may involve at least one check of a plurality of checks being deposited.

While the present invention has been illustrated by the description of example processes and system components, and while the various processes and components have been described in detail, applicant does not intend to restrict or in any limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

1. A method of operating a check image data processing facility to prevent a duplicate check from being deposited when a customer is attempting to deposit a check in a check deposit transaction at a remote deposit capture device which is remote from the check image data processing facility, the method comprising:
electronically by a processor, receiving from the remote deposit capture device check image data which is representative of an image of the check being attempted to be deposited by the customer conducting the check deposit transaction at the remote deposit capture device;
electronically by a processor, attempting to read a magnetic ink character recognition (MICR) code line from the check image;
electronically by a processor, determining if a MICR code line is readable from the check image;
electronically by a processor, determining if the MICR code line matches a MICR code line stored in a check item database when a MICR code line is readable from the check image;
electronically by a processor, extracting check data from at least one focus area of the check image when the MICR code line from the check image matches the MICR code line stored in the check item database;
electronically by a processor, determining if the check which is being attempted to be deposited by the customer is a duplicate check based upon the extracted check data from the at least one focus area of the check image; and
electronically by a processor, transmitting a message to the remote deposit capture device to indicate to the customer that the check which is being attempted to be deposited by the customer is a duplicate check when a determination is made that the check is a duplicate check and thereby to prevent the duplicate check from being deposited.

2. The method according to claim 1, wherein electronically by a processor, determining if the check which is being attempted to be deposited by the customer is a duplicate check includes:
electronically by a processor, calculating a metric associated with the at least one focus area of the check image based upon the extracted check data from the at least one focus area of the check image; and
electronically by a processor, calculating a difference between the calculated metric and an associated statistical value stored in the check item database, wherein the calculated difference is representative of whether or not the check which is being attempted to be deposited by the customer is a duplicate check.

3. The method according to claim 2, wherein electronically by a processor, transmitting a message to the remote deposit capture device to indicate to the customer that the check which is being attempted to be deposited by the customer is a duplicate check includes transmitting a message to the remote deposit capture device to indicate to the customer that the check which is being attempted to be deposited by the customer is a duplicate check when the calculated difference between the calculated metric and the associated statistical value stored in the check item database meets predetermined criteria.

4. The method according to claim 3, further comprising:
electronically by a processor, applying an associated weighting factor to each calculated difference between the calculated metric and the associated the statistical value stored in the check item database; and
electronically by a processor, summing the weighted differences.

5. The method according to claim 4, further comprising:
electronically by a processor, determining if the sum of the weighted differences is greater than a predetermined significance threshold; and
electronically by a processor, storing the check image in the check item database when the sum of the weighted differences is greater than the predetermined significance threshold.

6. The method according to claim 2, wherein electronically by a processor, calculating a metric associated with the at least one focus area of the check image includes creating at least one of a horizontal histogram and a vertical histogram.

7. The method according to claim 6, wherein creating at least one of a horizontal histogram and a vertical histogram includes creating both histograms.

8. The method according to claim 1, wherein the at least one focus area of the check image comprises any combination of a payee field, a memo field, a date field, a courtesy amount field, a legal amount field, and a payer signature field.

9. The method according to claim 1, wherein the method is performed by a computer having a memory executing one or more programs of instructions which are tangibly embodied in a program storage medium readable by the computer.

10. A method of processing check image data to prevent a duplicate check from being deposited when a customer is attempting to deposit a check in a check deposit transaction at a remote deposit capture device which is remote from a check image data processing facility, the method comprising:
electronically by a processor, receiving from the remote deposit capture device check image data which is representative of an image of the check which is being attempted to be deposited by the customer conducting the check deposit transaction at the remote deposit capture device;
electronically by a processor, attempting to read a magnetic ink character recognition (MICR) code line from the check image;
electronically by a processor, determining if a MICR code line is readable from the check image;
electronically by a processor, determining if the MICR code line matches a MICR code line stored in a check item database when a MICR code line is readable from the check image;
electronically by a processor, extracting check data from at least one focus area of the check image when the MICR code line from the check image matches the MICR code line stored in the check item database;
electronically by a processor, calculating a metric associated with the at least one focus area of the check image based upon the extracted check data from the at least one focus area of the check image;
electronically by a processor, calculating a difference between the calculated metric and an associated statistical value stored in the check item database;
electronically by a processor, determining if the check which is being attempted to be deposited by the customer is a duplicate check based upon the calculated difference between the calculated metric and the associated statistical value stored in the check item database; and
electronically by a processor, transmitting a message to the remote deposit capture device to indicate to the customer that the check which is being attempted to be deposited by the customer is a duplicate check when a determination is made that the check which is being attempted to be deposited by the customer is a duplicate check.

11. The method according to claim 10, further comprising:
electronically by a processor, applying an associated weighting factor to each calculated difference between the calculated metric and the associated the statistical value stored in the check item database; and
electronically by a processor, summing the weighted differences.

12. The method according to claim 11, further comprising:
electronically by a processor, determining if the sum of the weighted differences is greater than a predetermined significance threshold; and
electronically by a processor, storing the check image in the check item database when the sum of the weighted differences is greater than the predetermined significance threshold.

13. The method according to claim 10, wherein electronically by a processor, calculating a metric associated with the at least one focus area of the check image includes creating at least one of a horizontal histogram and a vertical histogram.

14. The method according to claim 13, wherein creating at least one of a horizontal histogram and a vertical histogram includes creating both histograms.

15. The method according to claim 10, wherein the at least one focus area of the check image comprises any combination of a payee field, a memo field, a date field, a courtesy amount field, a legal amount field, and a payer signature field.

16. The method according to claim 11, wherein the method is performed by a computer having a memory executing one or more programs of instructions which are tangibly embodied in a program storage medium readable by the computer.

17. A method of operating a check image data processing facility to prevent a duplicate check from being deposited when a customer is attempting to deposit a check in a check deposit transaction at a remote deposit capture device which is remote from the check image data processing facility, the method comprising:
electronically by a processor, receiving from the remote deposit capture device check image data which is representative of an image of the check being attempted to be deposited by the customer conducting the check deposit transaction at the remote deposit capture device;
electronically by a processor, attempting to read a magnetic ink character recognition (MICR) code line from the check image;
electronically by a processor, determining if a MICR code line is readable from the check image;
electronically by a processor, determining if the MICR code line matches a MICR code line stored in a check item database when a MICR code line is readable from the check image;
electronically by a processor, extracting check data from a payee field area of the check image when the MICR code line from the check image matches the MICR code line stored in the check item database;
electronically by a processor, determining if the check which is being attempted to be deposited by the customer is a duplicate check based upon the extracted check data from the payee field area of the check image; and
electronically by a processor, transmitting a message to the remote deposit capture device to indicate to the customer that the check which is being attempted to be deposited by the customer is a duplicate check when a determination is made that the check is a duplicate check based upon the check data extracted from the payee field area of the check image and thereby to prevent the duplicate check from being deposited.

18. The method according to claim 17, further comprising:
electronically by a processor, extracting check data from a memo field area of the check image when the MICR code line from the check image matches the MICR code line stored in the check item database;
electronically by a processor, determining if the check which is being attempted to be deposited by the customer is a duplicate check based upon the extracted check data from the memo field area of the check image; and
electronically by a processor, transmitting a message to the remote deposit capture device to indicate to the customer that the check which is being attempted to be deposited by the customer is a duplicate check when a determination is made that the check is a duplicate check based upon the check data extracted from the memo field area of the check image and thereby to prevent the duplicate check from being deposited.

19. The method according to claim 18, further comprising:
electronically by a processor, extracting check data from a date field area of the check image when the MICR code line from the check image matches the MICR code line stored in the check item database;
electronically by a processor, determining if the check which is being attempted to be deposited by the customer is a duplicate check based upon the extracted check data from the date field area of the check image; and
electronically by a processor, transmitting a message to the remote deposit capture device to indicate to the customer that the check which is being attempted to be deposited by the customer is a duplicate check when a determination is made that the check is a duplicate check based upon the check data extracted from the date field area of the check image and thereby to prevent the duplicate check from being deposited.

20. The method according to claim 17, wherein the method is performed by a computer having a memory executing one or more programs of instructions which are tangibly embodied in a program storage medium readable by the computer.
